(19) United States
(12) Patent Application Publication
(10) Pub. No.: US 2017/0123644 A1
(43) Pub. Date: May 4, 2017

(54) INTERFACE DISPLAY METHOD AND DEVICE

(71) Applicant: Xiaomi Inc., Beijing (CN)

(72) Inventors: Qiao REN, Beijing (CN); Sitai GAO, Beijing (CN); Enxing HOU, Beijing (CN)

(73) Assignee: Xiaomi Inc., Beijing (CN)

(21) Appl. No.: 15/143,193

(22) Filed: Apr. 29, 2016

(30) Foreign Application Priority Data
Oct. 30, 2015 (CN) 201510729109.3

(51) Int. Cl. G06F 3/0484; G06F 9/44; H04L 12/28; G06F 3/0482; H04L 12/24

(52) U.S. Cl. CPC G06F 3/04847; G06F 3/0482; H04L 41/22; H04L 12/2807; H04L 12/282; G06F 9/4443

(57) ABSTRACT

The present disclosure provides an interface display method and device. Aspects of the disclosure provide a method for providing a control interface in a terminal device. The method includes receiving an instruction to provide a graphical user interface (GUI) for controlling a plurality of electronic devices, identifying the plurality of electronic devices, acquiring respective control interface information of the plurality of electronic devices respectively, generating control interface components to combine the respective control interface information of the plurality of electronic devices in order to control the plurality of electronic devices, and presenting a GUI in the terminal device with the control interface components. The method improves the flexibility of interface display, and improves the user experience.

### CROSS-REFERENCE TO RELATED APPLICATIONS

This application is based upon and claims priority to Chinese Patent Application 201510729109.3, filed Oct. 30, 2015, the entire contents of which are incorporated herein by reference.

### TECHNICAL FIELD

The present disclosure generally relates to field of communication, and more particularly, to an interface display method and device.

### BACKGROUND

In the related art, through a terminal, a user may view control interfaces of other smart apparatuses bound with the terminal.

### SUMMARY

The present disclosure provides an interface display method and device.

Aspects of the disclosure provide a method for providing a control interface in a terminal device. The method includes receiving an instruction to provide a graphical user interface (GUI) for controlling a plurality of electronic devices, identifying the plurality of electronic devices, acquiring respective control interface information of the plurality of electronic devices respectively, generating control interface components to combine the respective control interface information of the plurality of electronic devices in order to control the plurality of electronic devices, and presenting a GUI in the terminal device with the control interface components.

According to an aspect of the disclosure, the method further includes providing a selection list of electronic devices that are bound with the terminal device, receiving selection information of multiple electronic devices from the selection list, and determining that the instruction to provide the GUI for controlling the multiple electronic devices is received.

To acquire the respective control interface information of the plurality of electronic devices respectively, in an example, the method includes sending a request with identities of the plurality of electronic devices to a preset server to request the preset server to acquire the control interface information of the plurality of electronic devices respectively, and receiving the control interface information of the plurality of electronic device returned by the preset server.

In an example, the control interface information comprises control interface components on GUIs that are used to respectively control the plurality of electronic devices. Then, to generate the control interface components to combine the respective control interface information of the plurality of electronic devices in order to control the plurality of electronic devices, the method includes determining combined control interface information of the GUI according to the respective control interface information of the plurality of electronic devices and generating at least one control interface component in the GUI according to the combined control information. Further, in an example, the method includes detecting an input operation on one of the control interface components in the GUI, generating an instruction in response to the input operation on the control interface component, and sending the instruction to a server to cause the server to forward the instruction to the plurality of electronic devices to make the plurality of electronic devices to perform a corresponding operation according to the instruction.

According to an aspect of the disclosure, the method includes detecting an input operation on one of the control interface components to cause corresponding operations on the plurality of electronic devices, and modifying an interface name of the GUI according to the corresponding operations on the plurality of electronic devices.

Aspects of the disclosure provide a device for controlling electronic devices. The device includes a display panel, a processor and a memory for storing instructions executable by the processor. The processor is configured to receive an instruction to provide a graphical user interface (GUI) for controlling a plurality of electronic devices, identify the plurality of electronic devices, acquire respective control interface information of the plurality of electronic devices respectively, generate control interface components in a graphical user interface (GUI) to combine the respective control interface information of the plurality of electronic devices in order to control the plurality of electronic devices, and cause the display panel to display the GUI with the control interface components.

Aspects of the disclosure also provide a non-transitory computer readable storage medium storing instructions that cause a processor to perform operations to provide a control interface. The operations include receiving an instruction to provide a graphical user interface (GUI) for controlling a plurality of electronic devices, identifying the plurality of electronic devices, acquiring respective control interface information of the plurality of electronic devices respectively, generating control interface components to combine the respective control interface information of the plurality of electronic devices in order to control the plurality of electronic devices; and presenting a graphic user interface (GUI) with the control interface components.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of an interface display method, according to an exemplary embodiment of the present disclosure;

FIG. 2 is a flow chart of another interface display method, according to an exemplary embodiment of the present disclosure;

FIG. 3 is a flow chart of further another interface display method, according to an exemplary embodiment of the present disclosure;

FIG. 4 is a flow chart of still another interface display method, according to an exemplary embodiment of the present disclosure;

FIG. 5 is a flow chart of still further another interface display method, according to an exemplary embodiment of the present disclosure;

FIG. 6 is a flow chart of still further another interface display method, according to an exemplary embodiment of the present disclosure;

FIG. 7 is a flow chart of still further another interface display method, according to an exemplary embodiment of the present disclosure;

FIGS. 8A-8D are schematic diagrams illustrating scenarios during various interface display procedure according to an exemplary embodiment of the present disclosure;

FIG. 9 is a block diagram of an interface display device according to an exemplary embodiment of the present disclosure;

FIG. 10 is a block diagram of another interface display device according to an exemplary embodiment of the present disclosure;

FIG. 11 is a block diagram of further another interface display device according to an exemplary embodiment of the present disclosure;

FIG. 12 is a block diagram of still another interface display device according to an exemplary embodiment of the present disclosure;

FIG. 13 is a block diagram of still further another interface display device according to an exemplary embodiment of the present disclosure;

FIG. 14 is a block diagram of still further another interface display device according to an exemplary embodiment of the present disclosure; and

FIG. 15 is a structural block diagram of a device for displaying an interface according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used in the present disclosure only tend to depict specific embodiments, rather than restricting the present disclosure. Unless the exceptional case in which the context clearly gives supports, the singular forms “a”, “an”, and “the” used in the present disclosure and accompany claims are intended to include the plural forms. It should also be appreciated that the expression “and/or” used herein indicates including any and all possible combinations of one or more of the associated listed items.

It should be understood, although terms first, second, third and the like are used in the present disclosure to depict various information, such information is not restricted by these terms. These terms are only used to distinguish information of the same type from each other. For example, without departing from the scope of the present disclosure, the first information may also be referred to as the second information. Similarly, the second information may also be referred to as the first information. Depending on context, the word “if” used herein may be explained to “when” or “upon” or “in response to determination that . . . ”.

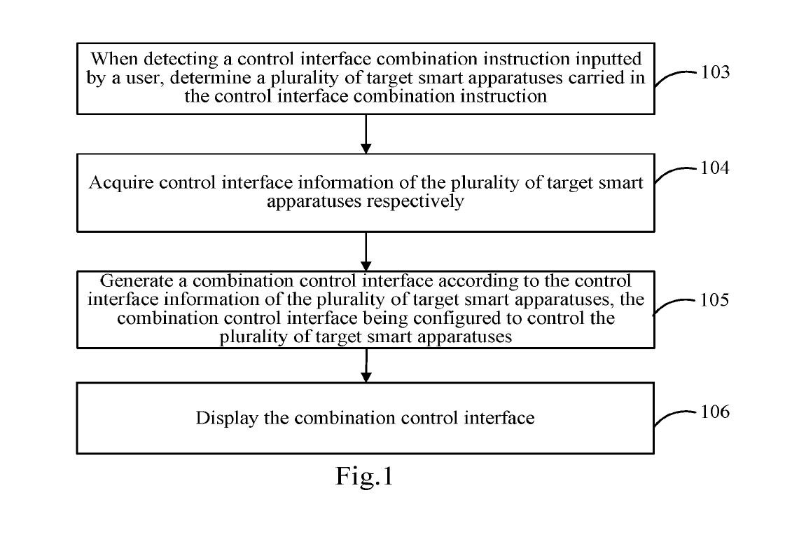

FIG. 1 is a flow chart of an interface display method, according to an exemplary embodiment. As shown in FIG. 1, the method may be applied in a terminal, and includes the following steps.

In step S101, when detecting a control interface combination instruction inputted by a user, a plurality of target smart apparatuses carried in the control interface combination instruction are determined.

The terminal involved in the embodiments of the present disclosure may be various smart terminals which could be carried by a user, such as a smart phone, a tablet, and a Personal Digital Assistant (PDA). The involved smart apparatus may be various smart electronic apparatuses in a smart home, such as a smart air conditioner, a smart air purifier, a smart curtain controller, a smart rice cooker, a smart water heater, and a smart refrigerator.

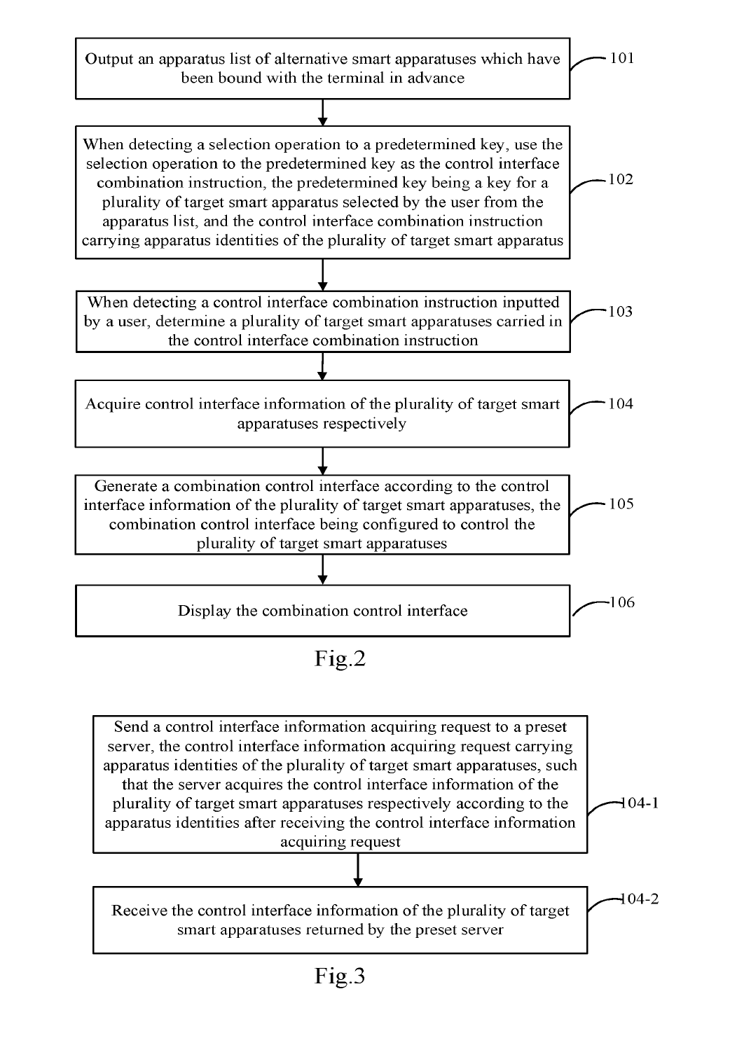

FIG. 2 is a flow chart of another interface display method, according to an exemplary embodiment of the present disclosure. Alternatively, as shown in FIG. 2, before performing step 103, the method may further include the following steps.

In step 101, an apparatus list of alternative smart apparatuses which have been bound with the terminal in advance is outputted.

In this step, the terminal may output the apparatus list according to relevant art, the apparatus list containing all alternative smart apparatuses which have been bound with the terminal in advance.

Alternatively, the user of the terminal may utilize a terminal identity (such as a mobile phone number) of the terminal to login in a smart home application (APP) which has been installed in the terminal in advance. Alternative smart apparatuses have been bound with an account of the smart home APP in advance. When the user logs in the smart home APP, the smart home APP may acquire apparatus identities of the alterative smart apparatuses from a preset server according to the account on the basis of relevant art, and then output the apparatus list of the alternative smart apparatuses according to the apparatus identities.

In step 102, when detecting a selection operation to a predetermined key, the selection operation to the predetermined key is used as the control interface combination instruction, the predetermined key being a key for a plurality of target smart apparatuses selected by the user from the apparatus list, and the control interface combination instruction carrying apparatus identities of the plurality of target smart apparatuses.

In this step, the terminal may output a virtual preset key, and when the terminal detects a selection operation to the preset key according to relevant art, the selection operation is determined to be a control interface combination instruction, i.e., the user selects to display the combination control interface. Since the preset key is a key with respect to multiple target smart apparatuses selected by the user in the apparatus list, the generated control interface combination instruction carries the apparatus identities of the multiple target smart apparatuses.

In the embodiments of the present disclosure, when the terminal detects the above selection operation, i.e., detects that the user inputs the control interface combination instruction, step 103 is performed so as to determine the apparatus identities of the plurality of target smart apparatuses carried in the control interface combination instruction according to the relevant art.

In step 104, control interface information of the plurality of target smart apparatuses are acquired respectively.

FIG. 3 is a flow chart of further another interface display method, according to an exemplary embodiment of the present disclosure. Alternatively, as shown in FIG. 3, step 104 may include the following steps.

In step 104-1, a control interface information acquiring request is sent to a preset server, the control interface information acquiring request carrying apparatus identities of the plurality of target smart apparatuses, in this way, the preset server acquires the control interface information of the plurality of target smart apparatuses respectively according to the apparatus identities after receiving the control interface information acquiring request.

In this step, after determining the apparatus identities of the plurality of target smart apparatuses carried in the control interface combination instruction, the terminal sends the control interface information acquiring request to a preset server, wherein the control interface information acquiring request carries the apparatus identities.

After receiving the control interface information acquiring request, the preset server respectively acquires individual control interface information of the plurality of target smart apparatuses according to the apparatus identities. Alternatively, the control interface information includes all button control information and demonstration control information on control interfaces corresponding to the plurality of target smart apparatuses.

In step 104-2, the control interface information of the plurality of target smart apparatuses returned by the preset server is received.

In this step, the terminal may receive the control interface information sent by the present server according to the relevant art.

In step 105, a combination control interface is generated according to the control interface information of the plurality of target smart apparatuses, the combination control interface being configured to control the plurality of target smart apparatuses.

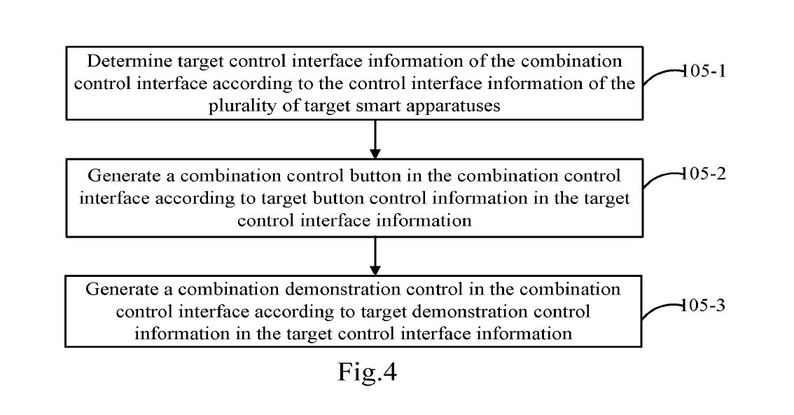

In the embodiments of the present disclosure, alternatively, as shown in FIG. 4 which illustrates another interface display method according to an exemplary embodiment, the step 105 may include the following steps.

In step 105-1, target control interface information of the combination control interface is determined according to the control interface information of the plurality of target smart apparatuses.

In this step, the terminal may determine the target control interface information of the combination control interface which needs to be displayed finally according to the acquired control interface information of the plurality of target smart apparatuses.

Alternatively, in the embodiments of the present disclosure, considering that the user needs to synchronously operate the plurality of target smart apparatuses via the combination control button on the combination control interface finally, the target control interface information may be the control interface information common to the plurality of the target smart apparatuses.

For example, the plurality of the target smart apparatuses include a smart apparatus A and a smart apparatus B, wherein control interface information corresponding to the smart apparatus A includes button control information a, button control information b, demonstration control information c, and demonstration control information d; and control interface information corresponding to the smart apparatus B includes button control information a, button control information b, demonstration control information e, and demonstration control information d. Then the finally determined target control interface information includes the button control information a, the button control information b, and the demonstration control information d.

Alternatively, in the embodiments of the present disclosure, the plurality of target smart apparatuses are the same smart apparatuses, for example, they are all smart curtain controllers, or smart air conditioners. Correspondingly, the target control interface information is the control interface information of one of the target smart apparatuses.

In step 105-2, a combination control button in the combination control interface is generated according to target button control information in the target control interface information.

In step 105-3, a combination demonstration control in the combination control interface is generated according to target demonstration control information in the target control interface information.

In the embodiments of the present disclosure, the terminal may respectively generate the combination control button and the combination demonstration control in the combination control interface according to the target button control information and the target demonstration control information in the target control interface information on the basis of the relevant art.

In step 106, the combination control interface is displayed.

In this step, the terminal displays the combination control interface generated by the above step 105 on the basis of the relevant art.

Alternatively, the combination control interface also needs to include names of the plurality of target smart apparatuses, such that the user may know which target smart apparatuses could be synchronously controlled by the current combination control interface.

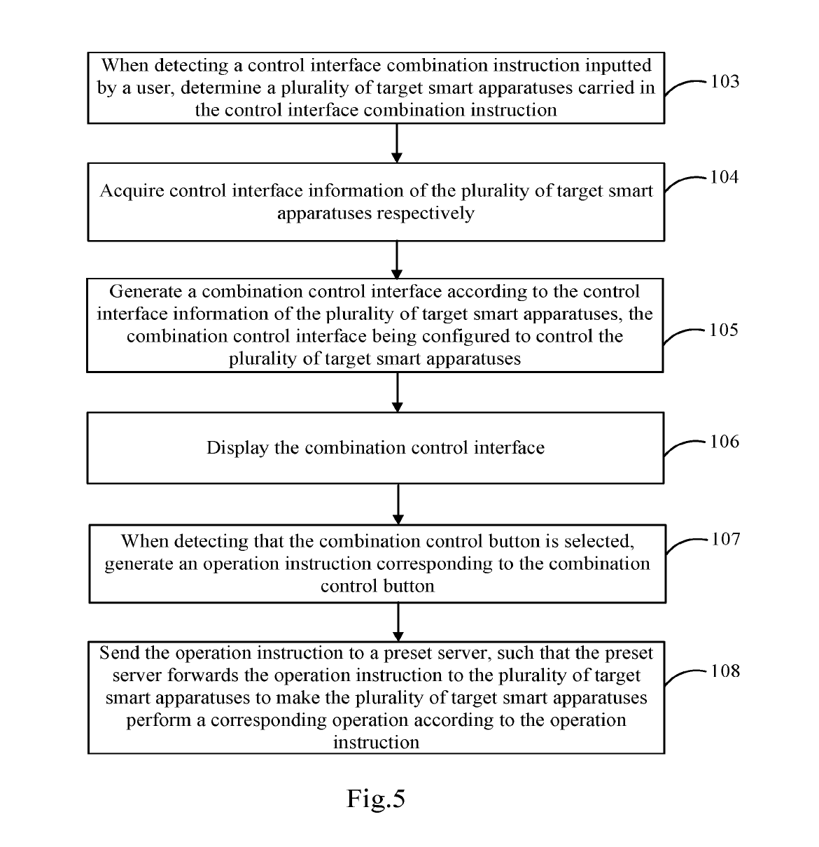

In the embodiments of the present disclosure, after completion of the above step 106, as shown in FIG. 5 which illustrates another interface display method according to an exemplary embodiment, the method may further include the following steps.

In step 107, when detecting that the combination control button is selected, an operation instruction corresponding to the combination control button is generated.

In this step, the terminal detects whether the user selects the combination control button on the combination control interface, and if the user selects the combination control button, then a corresponding operation instruction is generated according to the relevant art.

In step 108, the operation instruction is sent to a preset server, such that the preset server forwards the operation instruction to the plurality of target smart apparatuses to make the plurality of target smart apparatuses perform a corresponding operation according to the operation instruction.

In this step, after generating the operation instruction, the terminal sends it to the preset server, and then the preset server forwards it to the plurality of target smart apparatuses respectively. After receiving the operation instruction, each of the target smart apparatuses may perform a corresponding operation.

For example, the plurality of target smart apparatuses include a smart air conditioner and a smart air purifier, in this case, after the user selects a turn-on button, the terminal generates a turn-on operation instruction and sends it to a preset server, then the present server forwards it to the smart air conditioner and the smart air purifier, and then both the smart air conditioner and the smart air purifier perform the turn-on operation after receiving the turn-on operation instruction.

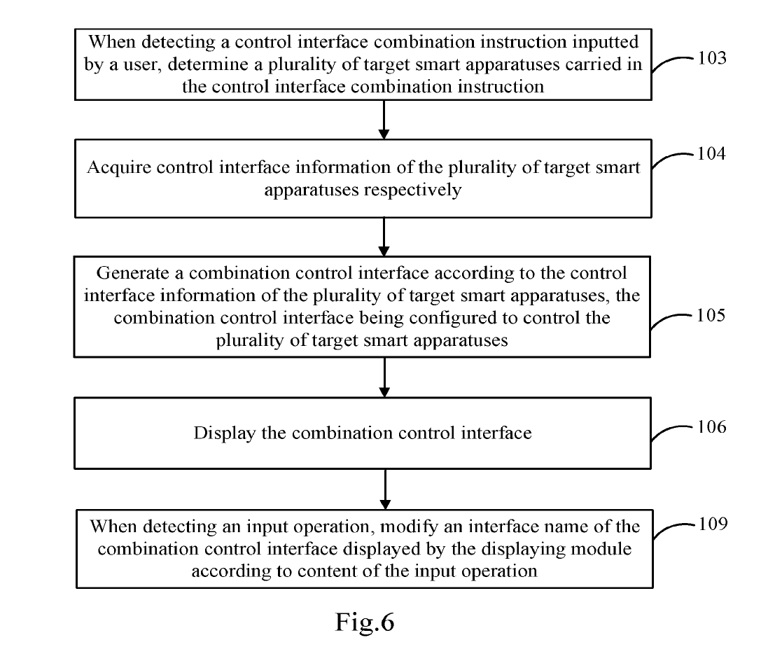

Alternatively, in the embodiments of the present disclosure, in order to further improve the flexibility of interface display, as shown in FIG. 6 which illustrates another interface display method according to an exemplary embodiment, after completion of the above step 106, the method may further include the following steps.

In step 109, when detecting an input operation, an interface name of the combination control interface is modified according to content of the input operation.

In this step, the terminal may detect whether there is an input operation according to the relevant art, and if an input operation is detected, then the terminal may modify the interface name of the display interface according to the content of the input operation on the basis of the relevant art.

For example, the interface name is “Two-in-one interface” originally, and the user modifies the interface name into “Room temperature controlling and adjusting interface” through an input operation.

The above-mentioned procedure may be completed by the smart home APP which has been installed in the terminal in advance. After the user logs in the smart home APP by using the terminal identity of the terminal, the smart home APP will output an apparatus list of alternative smart apparatuses which have been bound with the smart home APP account in advance, and output a preset key at the same time. After the user selects a plurality of target smart apparatuses from the apparatus list, the preset key is selected, the smart home APP will automatically acquire the control interface information of the plurality of target smart apparatuses, and then determine the target control interface information. The smart home APP generates and displays a combination control interface according to the target control interface information. Further, the user may select the combination control button on the combination control interface, so as to control the plurality of target smart apparatuses to perform corresponding operations.

In the above embodiments, a combination control interface for controlling the plurality of target smart apparatuses may be displayed on the terminal, and the user may select the combination control key displayed on the combination control interface, so as to synchronously control the plurality of target smart apparatuses to perform the operations corresponding to the combination control button, which improves the flexibility of interface display, and improves the user experience. Additionally, the above method may be applied in the smart home APP, thereby the availability is high.

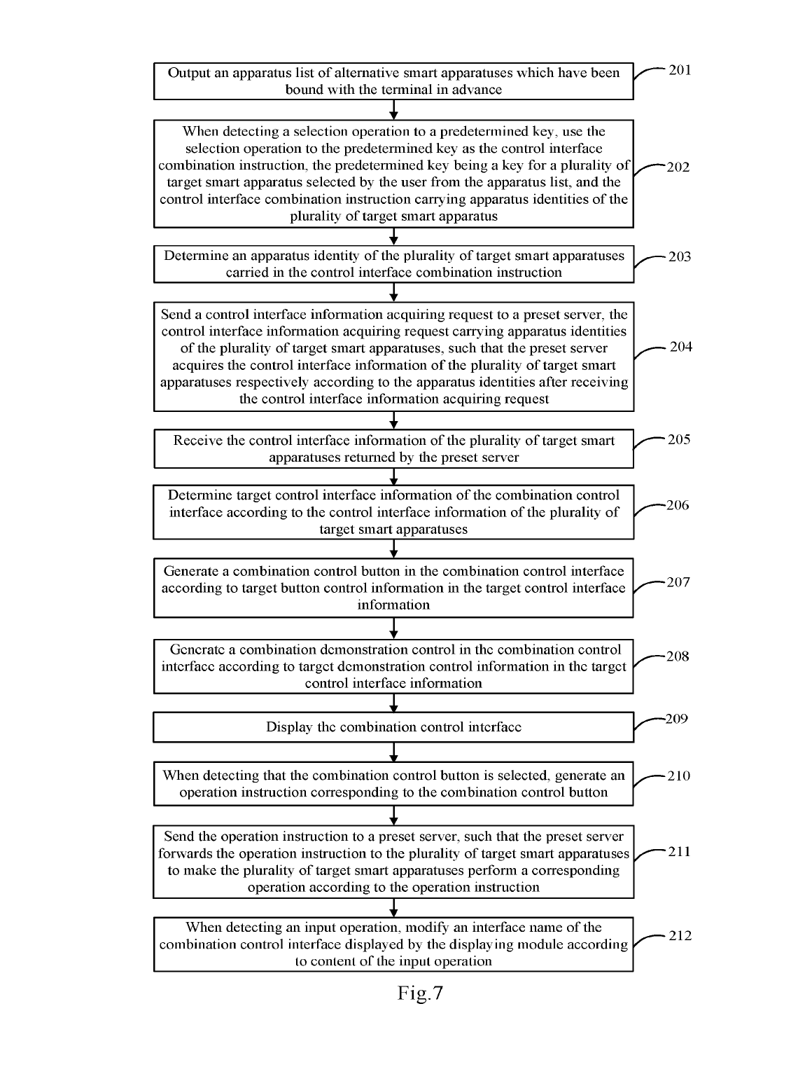

FIG. 7 illustrates another interface display method according to an exemplary embodiment. As shown in FIG. 7, the method includes the following steps.

In step 201, an apparatus list of alternative smart apparatuses which have been bound with the terminal in advance is outputted.

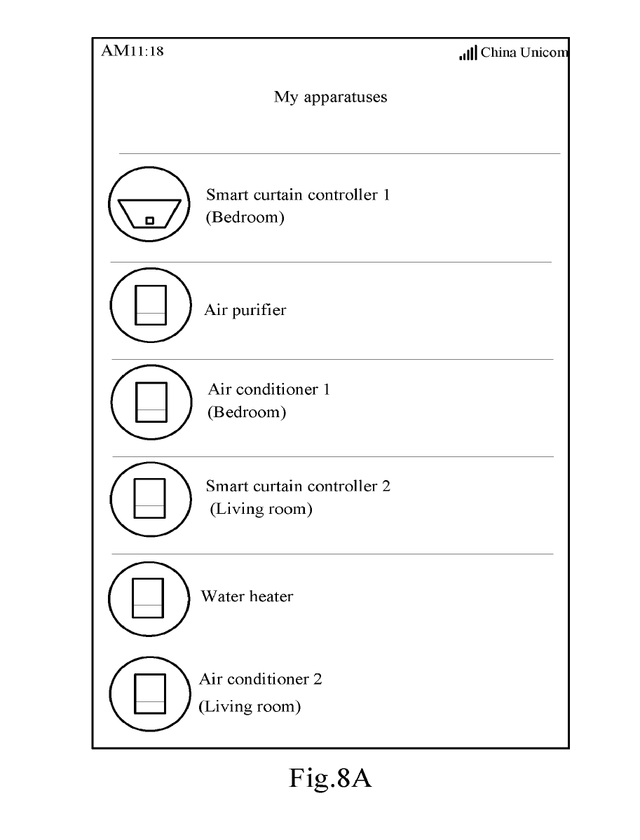

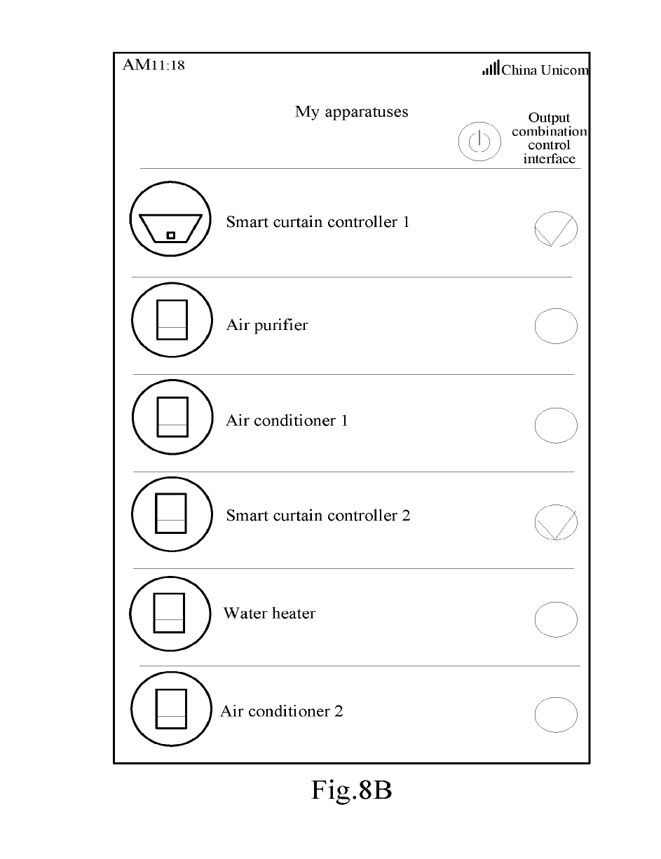

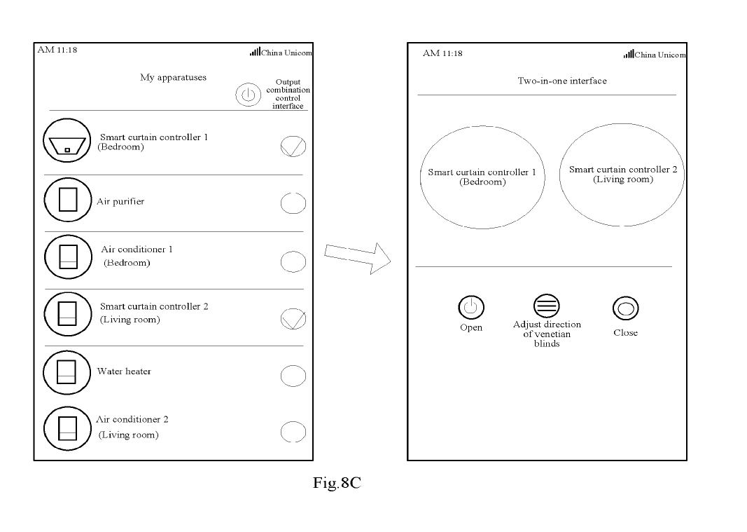

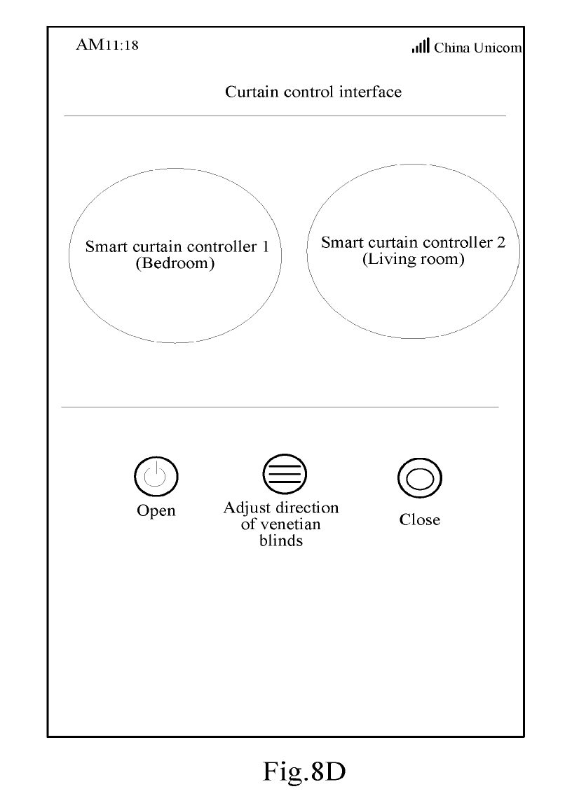

In this step, the terminal may output the apparatus list of alternative smart apparatuses which have been bound with the terminal in advance according to the relevant art, as shown in FIG. 8A.

In step 202, when detecting a selection operation to a predetermined key, the selection operation to the predetermined key is used as the control interface combination instruction, the predetermined key being a key for a plurality of target smart apparatuses selected by the user from the apparatus list, and the control interface combination instruction carrying apparatus identities of the plurality of target smart apparatuses.

In this step, the user may select the plurality of target smart apparatuses from the apparatus list, and then select a virtual preset key, as shown in FIG. 8B. The terminal determines the selection operation of selecting the preset key by the user as the control interface combination instruction, and the control interface combination instruction carries apparatus identities of the plurality of target smart apparatuses.

In step 203, apparatus identities of the plurality of target smart apparatuses carried in the control interface combination instruction are determined.

In step 204, a control interface information acquiring request is sent to a preset server, the control interface information acquiring request carrying apparatus identities of the plurality of target smart apparatuses, thereby the preset server acquires the control interface information of the plurality of target smart apparatuses respectively according to the apparatus identities after receiving the control interface information acquiring request.

In this step, the terminal sends the control interface information acquiring request carrying apparatus identities to the preset server. The preset server acquires respective control interface information of the plurality of target smart apparatuses according to the apparatus identities. Alternatively, the control interface information includes all button control information and demonstration control information on control interfaces corresponding to the plurality of target smart apparatuses.

In step 205, the control interface information of the plurality of target smart apparatuses returned by the preset server is received.

In step 206, target control interface information of the combination control interface is determined according to the control interface information of the plurality of target smart apparatuses.

Alternatively, the target control interface information may be the control interface information common to the plurality of the target smart apparatuses.

As shown in FIG. 8B, the user selects the same two smart apparatuses, i.e., smart curtain controllers, for respectively controlling curtains in the bedroom and in the living room. In this case, the target control interface information is the control interface information of one of the smart curtain controllers.

In step 207, a combination control button in the combination control interface is generated according to target button control information in the target control interface information.

In step 208, a combination demonstration control in the combination control interface is generated according to target demonstration control information in the target control interface information.

The above step 207 and step 208 may be performed synchronously. The terminal may respectively generate the combination control button and the combination demonstration control in the combination control interface according to the target button control information and the target demonstration control information in the target control interface information on the basis of the relevant art.

In step 209, the combination control interface is displayed.

The displayed combination control interface is as shown in FIG. 8C.

In step 210, when detecting that the combination control button is selected, an operation instruction corresponding to the combination control button is generated.

In this step, the terminal detects whether the user selects a combination control button on the combination control interface, and if the user selects the combination control button, then a corresponding operation instruction is generated according to the relevant art. For example, if the user selects an open button in the combination control interface shown in FIG. 8C, the terminal generates an open operation instruction.

In step 211, the operation instruction is sent to a preset server, such that the preset server forwards the operation instruction to the plurality of target smart apparatuses to make the plurality of target smart apparatuses perform a corresponding operation according to the operation instruction.

In this step, the preset server sends the operation instruction sent by the terminal to the plurality of target smart apparatuses. For example, the preset server forwards the open operation instruction to two smart curtain controllers in FIG. 8C. The above two smart curtain controllers open curtains in the bedroom and the living room when receiving the open operation instruction.

In step 212, when detecting an input operation, an interface name of the combination control interface is modified according to content of the input operation.

In this step, the terminal may modify the interface name of the display interface according to the content of the input operation on the basis of the relevant art.

For example, the interface name is “Two-in-one interface” originally, and the user modifies the interface name into “Curtain controlling interface” through an input operation, as shown in FIG. 8D.

In the above embodiments, the terminal may output an apparatus list of alternative smart apparatuses, and when detecting that the user selects a preset key, it is determined that a control interface combination instruction inputted by the user is received. Then, the combination control interface being capable of controlling the plurality of target smart apparatuses may be displayed according to the control interface combination instruction, which improves the flexibility of interface display. The user may select the combination control key displayed on the combination control interface, so as to synchronously control the plurality of target smart apparatuses to perform the operation corresponding to the combination control button, in this way, the user experience is good.

Corresponding to the above-mentioned method embodiments, the present disclosure also provides device embodiments.

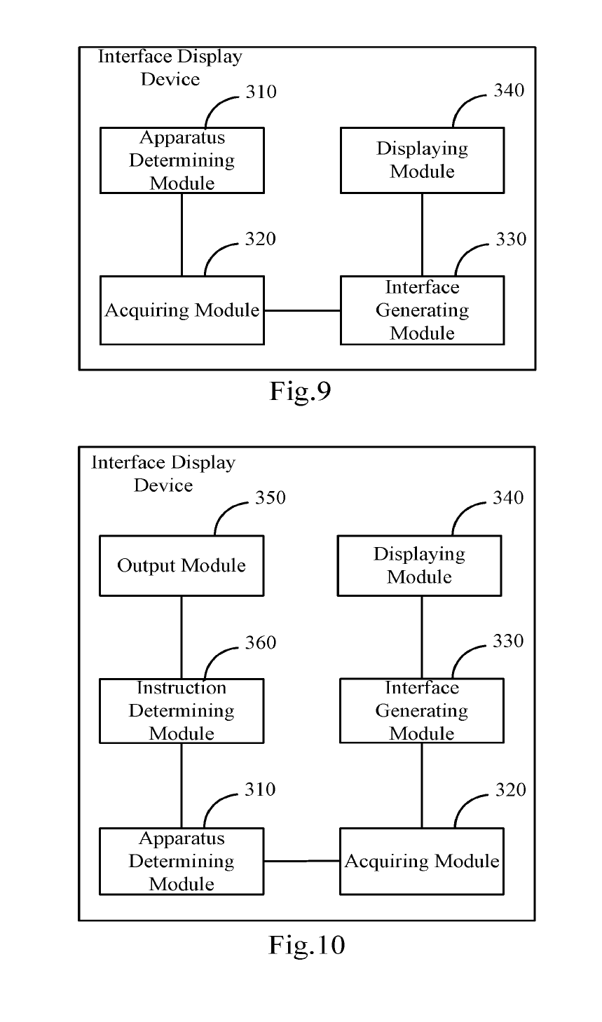

FIG. 9 is a block diagram of an interface display device according to an exemplary embodiment of the present disclosure. As shown in FIG. 9, the interface display device is applied in a terminal, and includes: an apparatus determining module 310, an acquiring module 320, an interface generating module 330, and a displaying module 340.

The apparatus determining module 310 is configured to, when detecting a control interface combination instruction inputted by a user, determine a plurality of target smart apparatuses carried in the control interface combination instruction.

The acquiring module 320 is configured to respectively acquire control interface information of the plurality of target smart apparatuses determined by the apparatus determining module 310.

The interface generating module 330 is configured to generate a combination control interface according to the control interface information of the plurality of target smart apparatuses acquired by the acquiring module 320, the combination control interface being configured to control the plurality of target smart apparatuses.

The displaying module 340 is configured to display the combination control interface generated by the interface generating module 330.

FIG. 10 is a block diagram of another interface display device according to an exemplary embodiment of the present disclosure. As shown in FIG. 10, on the basis of the above embodiment shown in FIG. 9, the device in the present embodiment may further include: an output module 350, and an instruction determination module 360.

The output module 350 is configured to output an apparatus list of alternative smart apparatuses which have been bound with the terminal in advance.

The instruction determination module 360 is configured to, when detecting a selection operation to a predetermined key, use the selection operation to the predetermined key as the control interface combination instruction, the predetermined key being a key for a plurality of target smart apparatuses selected by the user from the apparatus list outputted from the output module 350, and the control interface combination instruction carrying apparatus identities of the plurality of target smart apparatuses.

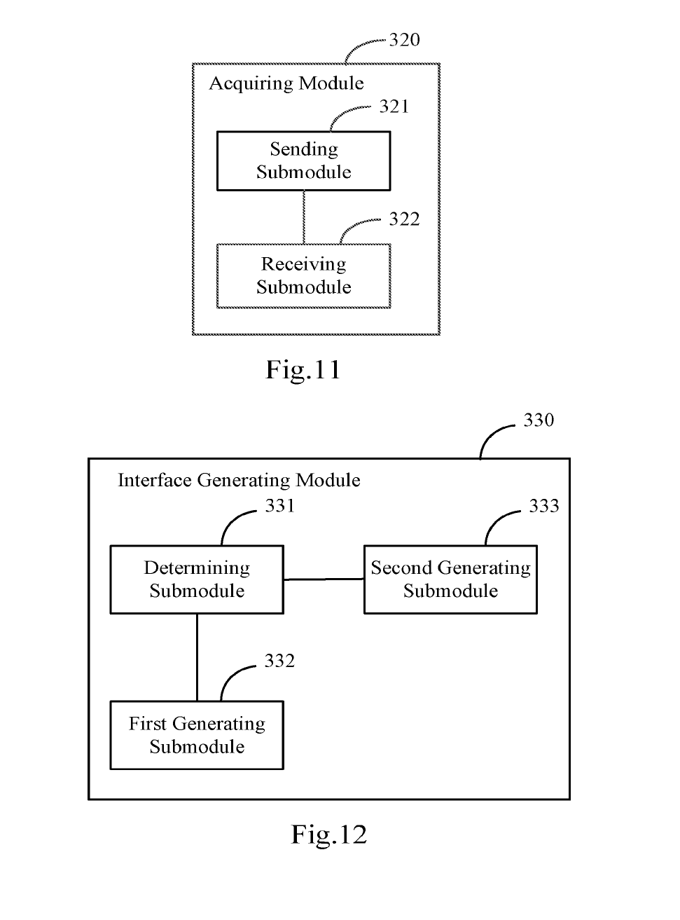

FIG. 11 is a block diagram of further another interface display device according to an exemplary embodiment of the present disclosure. As shown in FIG. 11, on the basis of the above embodiment shown in FIG. 9, the acquiring module 320 includes: a sending submodule 321, and a receiving submodule 322.

The sending submodule 321 is configured to send a control interface information acquiring request to a preset server, the control interface information acquiring request carrying apparatus identities of the plurality of target smart apparatuses determined by the apparatus determining module 310, thereby the server acquires the control interface information of the plurality of target smart apparatuses respectively according to the apparatus identities after receiving the control interface information acquiring request.

The receiving submodule 322 is configured to receive the control interface information of the plurality of target smart apparatuses returned by the preset server.

Alternatively, the control interface information acquired by the acquiring module 320 includes all button control information and demonstration control information on control interfaces corresponding to the plurality of target smart apparatuses.

FIG. 12 is a block diagram of still another interface display device according to an exemplary embodiment of the present disclosure. As shown in FIG. 12, on the basis of the above embodiments shown in any of FIGS. 9-11, the interface generating module 330 includes: a determining submodule 331, a first generating submodule 332, and a second generating submodule 333.

The determining submodule 331 is configured to determine target control interface information of the combination control interface according to the control interface information of the plurality of target smart apparatuses acquired by the acquiring module 320.

The first generating submodule 332 is configured to generate a combination control button in the combination control interface according to target button control information in the target control interface information determined by the determining submodule 331.

The second generating submodule 333 is configured to generate a combination demonstration control in the combination control interface according to target demonstration control information in the target control interface information determined by the determining submodule 331.

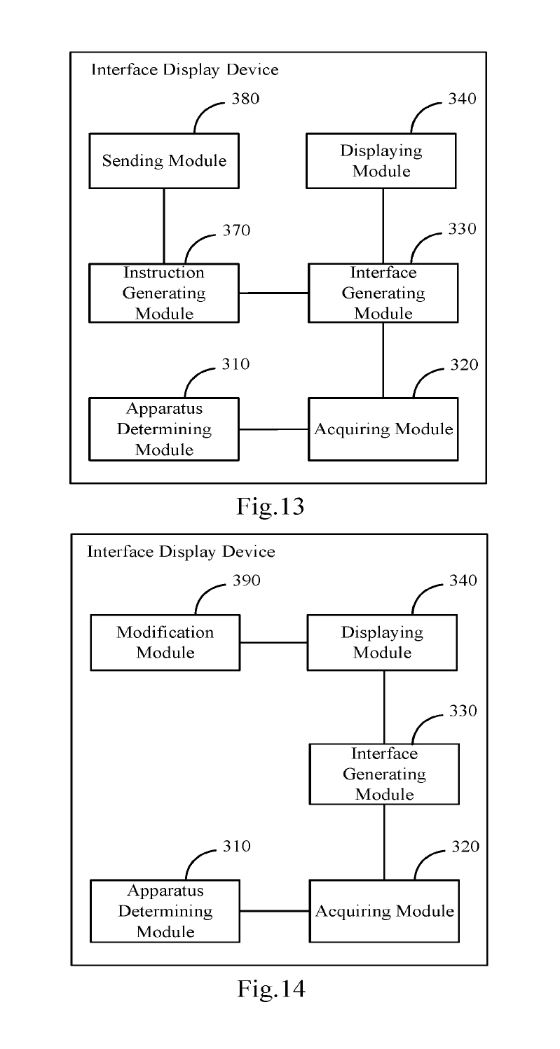

FIG. 13 is a block diagram of still further another interface display device according to an exemplary embodiment of the present disclosure. As shown in FIG. 13, on the basis of the above embodiment shown in FIG. 12, the device further includes: an instruction generating module 370, and a sending module 380.

The instruction generating module 370 is configured to, when detecting that the combination control button generated by the first generating submodule 332 is selected, generate an operation instruction corresponding to the combination control button.

The sending module 380 is configured to send the operation instruction generated by the instruction generating module to a preset server, such that the preset server forwards the operation instruction to the plurality of target smart apparatuses to make the plurality of target smart apparatuses perform a corresponding operation according to the operation instruction.

FIG. 14 is a block diagram of still further another interface display device according to an exemplary embodiment of the present disclosure. As shown in FIG. 14, on the basis of the above embodiment shown in FIG. 9, the device further includes: a modification module 390.

The modification module 390 is configured to, when detecting an input operation, modify an interface name of the combination control interface displayed by the displaying module according to content of the input operation.

With respect to the devices in the above embodiments, the specific manners for performing operations for individual modules therein have been described in detail in the embodiments regarding the methods, which will not be elaborated herein.

For device embodiments, since they are substantially corresponding to the method embodiments, the relevant contents may be referred to some explanations in the method embodiments. The above-described device embodiments are only illustrative. The units illustrated as separate components may be or may not be separated physically, the component used as a unit display may be or may not be a physical unit, i.e., may be located at one location, or may be distributed into multiple network units. A part or all of the modules may be selected to achieve the purpose of the solution in the present disclosure according to actual requirements. The person skilled in the art can understand and implement the present disclosure without paying inventive labor.

In addition, the present disclosure further provides an interface display device applied in a terminal, including:

a processor; and

a memory for storing instructions executable by the processor;

wherein the processor is configured to:

when detecting a control interface combination instruction inputted by a user, determine a plurality of target smart apparatuses carried in the control interface combination instruction;

acquire control interface information of the plurality of target smart apparatuses respectively;

generate a combination control interface according to the control interface information of the plurality of target smart apparatuses, the combination control interface being configured to control the plurality of target smart apparatuses; and

display the combination control interface.

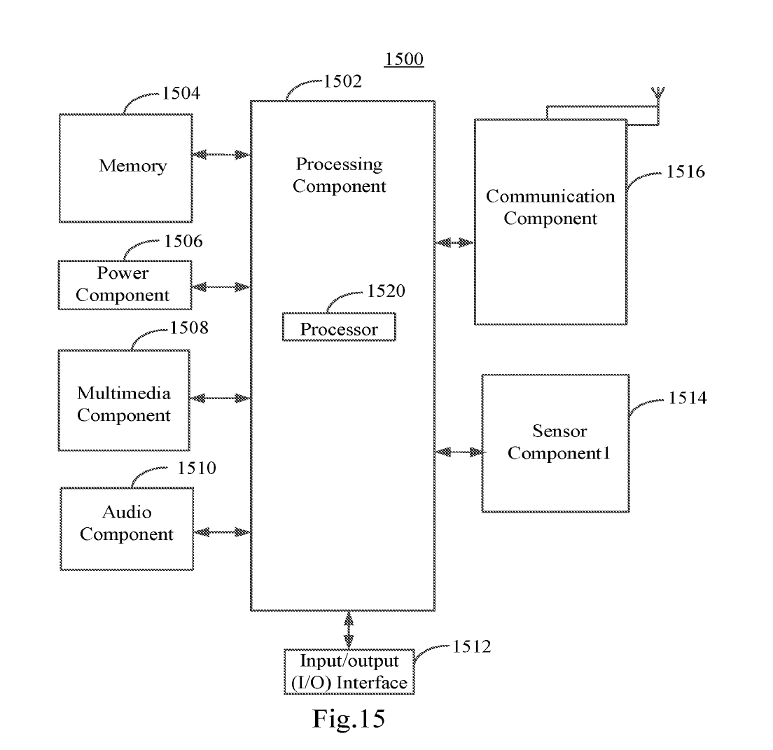

FIG. 15 is a structural block diagram of an interface display device 1500 according to an exemplary embodiment of the present disclosure. As shown in FIG. 15, for example, the device 1500 may include a terminal, and the terminal may be a mobile phone, a computer, a digital broadcast terminal, a messaging device, a smart plug, a smart blood pressure meter, a gaming console, a tablet, a medical device, exercise equipment, a personal digital assistant, a smart wrist, a smart watch and the like.

Referring to FIG. 15, the device 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the device 1500, such as the operations associated with display, telephone calls, data communications, camera operations, and recording operations. The processing component 1502 may include one or more processors 1520 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the device 1500. Examples of such data include instructions for any applications or methods operated on the device 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the device 1500. The power component 1506 may include a power management system, one or more power sources, and any other components associated with the generation, management, and distribution of power in the device 1500.

The multimedia component 1508 includes a screen providing an output interface between the device 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the device 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone (“MIC”) configured to receive an external audio signal when the device 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the device 1500. For instance, the sensor component 1514 may detect an open/closed status of the device 1500, relative positioning of components, e.g., the display and the keypad, of the device 1500, a change in position of the device 1500 or a component of the device 1500, a presence or absence of user contact with the device 1500, an orientation or an acceleration/deceleration of the device 1500, and a change in temperature of the device 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication component 1516 is configured to facilitate communication, wired or wirelessly, between the device 1500 and other devices. The device 1500 can access a wireless network based on a communication standard, such as WiFi, 2G, or 3G, or a combination thereof. In one exemplary embodiment, the communication component 1516 receives a broadcast signal or broadcast associated information from an external broadcast management system via a broadcast channel. In one exemplary embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1504, executable by the processor 1520 in the device 1500, for performing the above-described methods. For example, the non-transitory computer-readable storage medium may be a ROM, a RAM, a CD-ROM, a magnetic tape, a floppy disc, an optical data storage device, and the like.

It is noted that the various modules, sub-modules, units and components in the present disclosure can be implemented using any suitable technology. In an example, a module can be implemented using circuitry, such as integrated circuit (IC). In another example, a module can be implemented as a processing circuit executing software instructions.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for providing a control interface in a terminal device, comprising:
receiving an instruction to provide a graphical user interface (GUI) for controlling a plurality of electronic devices;
identifying the plurality of electronic devices;
acquiring respective control interface information of the plurality of electronic devices respectively;
generating control interface components to combine the respective control interface information of the plurality of electronic devices in order to control the plurality of electronic devices; and
presenting a GUI in the terminal device with the control interface components.

2. The method of claim 1, further comprising:
providing a selection list of electronic devices that are bound with the terminal device;
receiving selection information of multiple electronic devices from the selection list; and
determining that the instruction to provide the GUI for controlling the multiple electronic devices is received.

3. The method of claim 1, wherein acquiring the respective control interface information of the plurality of electronic devices respectively comprises:
sending a request with identities of the plurality of electronic devices to a preset server to request the preset server to acquire the control interface information of the plurality of electronic devices respectively; and
receiving the control interface information of the plurality of electronic device returned by the preset server.

4. The method of claim 1, wherein the control interface information comprises control interface components on GUIs that are used to respectively control the plurality of electronic devices.

5. The method of claim 4, wherein generating the control interface components to combine the respective control interface information of the plurality of electronic devices in order to control the plurality of electronic devices comprises:
determining combined control interface information of the GUI according to the respective control interface information of the plurality of electronic devices; and
generating at least one control interface component in the GUI according to the combined control information.

6. The method of claim 5, further comprising:
detecting an input operation on one of the control interface components in the GUI;
generating an instruction in response to the input operation on the control interface component; and
sending the instruction to a server to cause the server to forward the instruction to the plurality of electronic devices to make the plurality of electronic devices to perform a corresponding operation according to the instruction.

7. The method of claim 1, further comprising:
detecting an input operation on one of the control interface components to cause corresponding operations on the plurality of electronic devices; and
modifying an interface name of the GUI according to the corresponding operations on the plurality of electronic devices.

8. A device for controlling electronic devices, comprising:
a display panel;
a processor; and
a memory for storing instructions executable by the processor;
wherein the processor is configured to:
receive an instruction to provide a graphical user interface (GUI) for controlling a plurality of electronic devices;
identify the plurality of electronic devices;
acquire respective control interface information of the plurality of electronic devices respectively;
generate control interface components in a graphical user interface (GUI) to combine the respective control interface information of the plurality of electronic devices in order to control the plurality of electronic devices; and
cause the display panel to display the GUI with the control interface components.

9. The device of claim 8, wherein the processor is further configured to:
provide a selection list of electronic devices that are bound with the terminal device;
receive selection information of multiple electronic devices from the selection list; and
determine that the instruction to provide the GUI for controlling the multiple electronic devices is received.

10. The device of claim 8, wherein the processor is further configured to:
send a request with identities of the plurality of electronic devices to a preset server to request the preset server to acquire the control interface information of the plurality of electronic devices respectively; and
receive the control interface information of the plurality of electronic device returned by the preset server.

11. The device of claim 8, wherein the control interface information comprises control interface components on GUIs that are used to respectively control the plurality of electronic devices.

12. The device of claim 11, wherein the processor is further configured to:
determine combined control interface information of the GUI according to the respective control interface information of the plurality of electronic devices; and
generating at least one control interface component in the GUI according to the combined control information.

13. The device of claim 12, wherein the processor is further configured to:
detect an input operation on one of the control interface components in the GUI;
generate an instruction in response to the input operation on the control interface component; and
send the instruction to a server to cause the server to forward the instruction to the plurality of electronic devices to make the plurality of electronic devices to perform a corresponding operation according to the instruction.

14. The device of claim 8, wherein the processor is further configured to:
detect an input operation on one of the control interface components to cause corresponding operations on the plurality of electronic devices; and
modify an interface name of the GUI according to the corresponding operations on the plurality of electronic devices.

15. A non-transitory computer readable storage medium storing instructions that cause a processor to perform operations to provide a control interface, the operations comprising:
receiving an instruction to provide a graphical user interface (GUI) for controlling a plurality of electronic devices;
identifying the plurality of electronic devices;
acquiring respective control interface information of the plurality of electronic devices respectively;
generating control interface components to combine the respective control interface information of the plurality of electronic devices in order to control the plurality of electronic devices; and
displaying a graphic user interface (GUI) with the control interface components.
